(19) United States
(12) Patent Application Publication
(10) Pub. No.: US 2006/0115318 A1
(43) Pub. Date: Jun. 1, 2006

(54) Ball-point pen with means of preventing inclination of the straight portion of the ball-pressing spring

(75) Inventors: Sergio Santini, Breganzona (CH); Donato Marotta, Caslano (CH)

Correspondence Address: YOUNG & THOMPSON, 745 SOUTH 23RD STREET, 2ND FLOOR, ARLINGTON, VA, 22202, US

(73) Assignee: PREMEC S.A., Cadempino (CH)

(21) Appl. No.: 10/559,772

(22) PCT Filed: Dec. 16, 2004
(86) PCT No.: PCT/IB04/04200

§ 371 Date: Dec. 7, 2005

(30) Foreign Application Priority Data
Dec. 29, 2003 (CH) 02220103

(51) Int. Cl. B43K 7/10

(52) U.S. Cl. 401/214; 401/216

(57) ABSTRACT

A ball-point pen (1) includes a reservoir (2) communicating with a hole (10) connected to a capillary channel (3) of a tip (4) which is provided with a cavity (9) which seats the ball (5) for writing, this ball (5) being kept pressed against a retaining edge (9t) of the cavity (9) as a result of the thrust of a compression resilient spring (6) terminating in a straight portion (6r) which is aligned with the longitudinal axis (N-N) of the ball-point pen (1) and the free end (6p) of which is in contact with the ball (5). In the ball-point pen (1), the capillary channel (3) has, inside it, elements (7) which, coming into contact with the straight portion (6r) of the spring (6), prevent it from becoming inclined with respect to the longitudinal axis (N-N) of the ball-point pen (1).

The present invention relates to the technical sector of ball-point pens. As is known, these pens comprise an ink reservoir which communicates with a usually cylindrical hole connected to the capillary channel of a tip which has a cavity inside which the ball for writing is seated.

This ball, when the pen is not writing, is kept pressed against a retaining edge, which is also formed on the said tip, in order to prevent the ink from escaping, and this function is performed by a compression-resilient spring which presses on the ball by means of the free end of a straight portion with which the said spring terminates. When the pen is used, being pressed against the surface on which it must write, the abovementioned ball is pressed towards the inside of the tip and, overcoming the resistance of the spring, is displaced from the retaining edge by an amount sufficient to allow the ink used for writing to pass outside.

Since the dimensions of the various component parts named hitherto are, as is known, very small, the abovementioned straight portion of the spring also has a very small diameter (of the order of a few tenths of a millimetre) and, when it is pressed axially during writing, it frequently slides on the surface of the ball, flexing with respect to the remaining part of the spring, and, being deviated from the initial position coinciding with the longitudinal axis of the ball-point pen, is positioned with the free end arranged on a side point of the ball situated in the vicinity of the said retaining edge.

In this position, the straight portion of the spring exerts on the ball, during writing, a force which has a considerable transverse component which keeps the said ball pressed transversely against the retaining edge and, since play is necessarily present between the latter and the ball, the annular cross section through which the ink flows out is not symmetrical with respect to the axis of the pen, having a length which, instead of being constant, varies from zero to a maximum value proceeding circumferentially around the ball, reaching at said maximum value a size which allows the ink to flow out at a rate greater than the flowrate envisaged during the design stage, which flowrate is calculated according to the viscosity of the ink and a uniform width of the annular flow cross section.

The above causes the appearance, along the writing lines, of blotches which are randomly arranged, creating an unaesthetic effect which is automatically associated with a poor quality of the pen.

Moreover, in the region of the abovementioned blotches, the ink, forming zones which have a greater than normal thickness, is unable to dry rapidly and, if inadvertently one brushes against said blotches with one's hand or arm, the result is to cause them to spread, producing unaesthetic smears and also dirtying one's hand or arm.

The inventor of the subject of the present application has aimed to provide a solution to the problem described hitherto and has devised a ball-point pen of the type described above, where the said capillary channel, through which the said straight portion of the ball-pressing spring passes, is provided with means able to prevent this portion from inclining with respect to the longitudinal axis of the pen.

In certain embodiments of the invention, these means consist of enlarged portions which create a narrow section of the capillary channel inside which the said straight portion of the spring is inserted in an approximately complementary manner with a minimum amount of play.

The subject of the present invention therefore consists of a ball-point pen as described in the accompanying Claim 1. A more detailed description of two preferred embodiments of the ball-point pen according to the invention will now be provided, with reference also to the accompanying drawings in which:

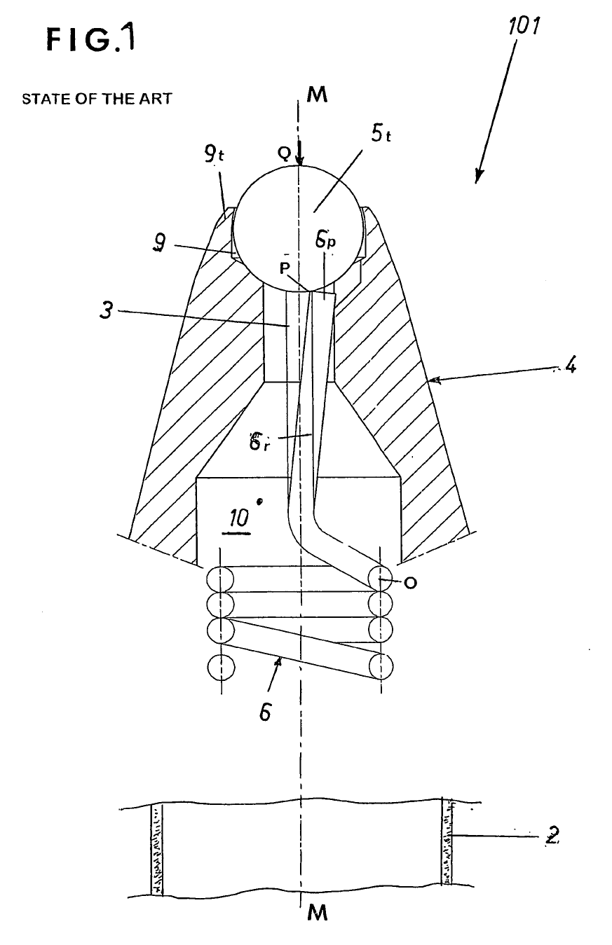

FIG. 1 is an enlarged longitudinal cross section through some parts of a ball-point pen designed in accordance with the present state of the art, while it is being used for writing;

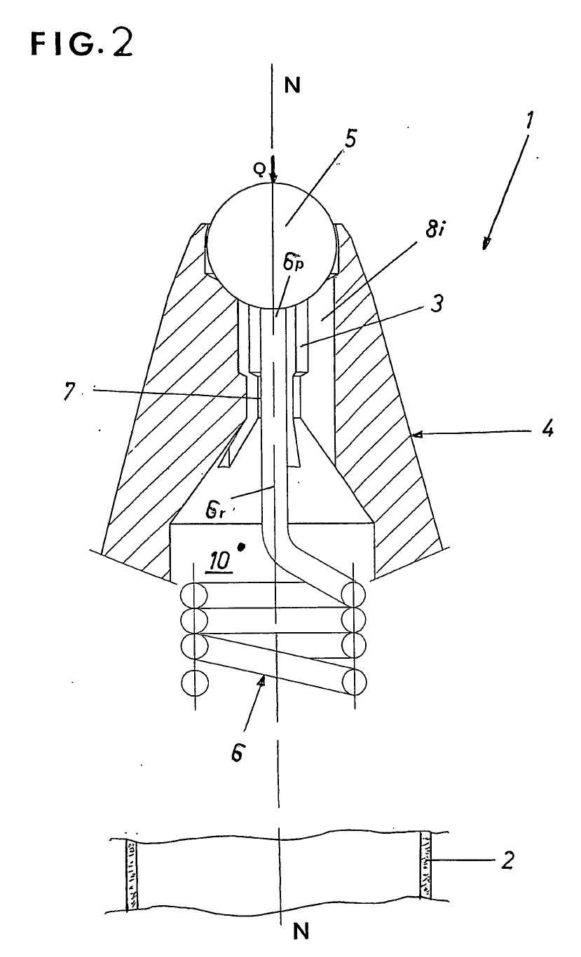

FIG. 2 is an enlarged longitudinal cross section through some parts of a first example of embodiment of a ball-point pen according to the invention;

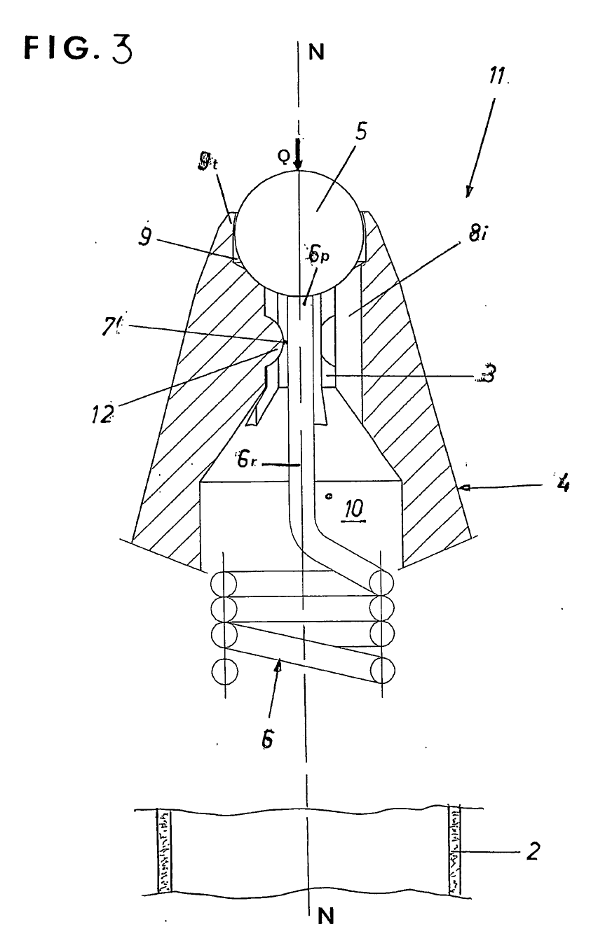

FIG. 3 is an enlarged longitudinal cross section through some parts of a second example of embodiment of a ball-point pen according to the invention.

If we consider FIG. 1, it can be seen therein how a ball-point pen 101 according to the state of the art comprises an ink reservoir (only a small part of which is schematically shown) communicating with a cylindrical hole 10 connected to a capillary channel 3 of a tip 4 which is provided with a cavity 9 which seats the ball 5 for writing and inside which the said capillary channel 3 terminates.

This ball is kept pressed against a retaining edge 9t formed on the contour towards the outside of the said cavity 9, by the thrust exerted by a compression-resilient spring 6 which terminates in a straight portion 6r aligned with the longitudinal axis M-M of the ball-point pen 101, the free end 6p of which (shown in continuous lines) is in contact with the ball 5. This straight portion 6r passes coaxially through a cylindrical capillary channel 3 and, when the ball-point pen 101 is used for writing, as shown in the figure, the force Q acting on the ball 5 is transmitted to it at a point P and causes flexing thereof with respect to the point O where the straight portion 6r is connected to the remaining parts of the spring 6, causing it to incline (to the right in the drawing) with respect to the said axis M-M.

Consequently, from that moment onwards, the straight portion 6r exerts on the ball 5 a non-axial reactive force which has a significant component in the transverse direction which causes the disadvantageous effects described above.

In FIG. 2, instead, it can be seen how, in a first example of embodiment 1 of a ball-point pen according to the invention, the phenomenon described above is avoided by creating in the capillary channel 3 a cylindrical narrow section 7 which has an axis coinciding with the longitudinal axis N-N of the pen, is passed through by the straight portion 6r of the spring 6 and has dimensions and a shape which practically complement that of the latter (apart from a very small amount of play—accentuated in the drawing—which is left to allow for any thermal expansion of the material from which the spring 6 is made, which differs slightly from the thermal expansion of the material from which the tip 4 is made). Since, in the situation illustrated above, there could be an obstruction in the flow of the ink through the said narrow section 7, which is partially occluded by the straight portion 6r of the spring 6, the inventor has envisaged the possibility of forming one or more radial through-grooves 8i which connect the aforementioned cavity 9 seating the ball 5 to the said hole with which the ink reservoir 2 communicates.

FIG. 3 shows how, in a second example of embodiment 11 of the ball-point pen according to the invention, all the various component parts mentioned in the description of the first example of embodiment are identical (and for this reason are indicated by the same reference numbers), except for the said narrow section 7′ which, in this case, does not consist of a cylindrical restriction, but is formed, inside the capillary channel 3, by means of a ring 12 which has a semi-circular cross section projecting inwards and has an axis coinciding with the longitudinal axis N-N of the ball-point pen 11.

In both the cases illustrated in FIGS. 2 and 3, the said narrow sections 7, 7′, irrespective of their form, keep substantially fixed, i.e. oriented along the longitudinal axis N-N of the ball-point pen 1, 11, the straight portion 6r of the spring 6, the free end 6p of which therefore always presses axially on the ball 5 in a substantially central position, avoiding the abovementioned drawbacks.

With a ball-point pen according to the invention, it has therefore been possible to achieve the predefined object of the inventor, namely that of providing a ball-point pen with writing lines which are more uniform and without the formation of blotches and/or ragged edges.

1. Ball-point pen (1,11) comprising a reservoir (2) communicating with a hole (10) connected to a capillary channel (3) of a tip (4) which is provided with a cavity (9) which seats the ball (5) for writing, this ball (5) being kept pressed against a retaining edge (9t) of the abovementioned cavity (9) as a result of the thrust of a compression-resilient spring (6) terminating in a straight portion (6r) which is aligned with the longitudinal axis (N-N) of the ball-point pen (1) and the free end (6p) of which is in contact with the said ball (5), characterized in that said capillary channel (3) has, inside it, means (7,7′) which, coming into contact with the said straight portion (6r) of the spring (6), prevent it from becoming inclined with respect to the said longitudinal axis (N-N) of the ball-point pen (1).

2. Ball-point pen according to claim 1, characterized in that the said capillary channel (3) has a narrow section (7,7′) which, being passed through in the axial direction by the said straight portion (6r) of the spring (6), is designed with dimensions such as to contain said portion in an approximately complementary manner with a minimum amount of play, substantially preventing it from assuming inclined positions with respect to the abovementioned longitudinal axis (N-N).

3. Ball-point pen according to claim 2, in which one or more through-grooves (8i) are formed in the region of the said narrow section (7), said through-grooves connecting the cavity (9) inside which the said ball is seated to the hole (10) with which the said reservoir (2) communicates.

4. Ball-point pen according to claim 2, in which the said narrow section is formed by a cylindrical shaped restriction (7).

5. Ball-point pen according to claim 2, in which the said narrow section is defined by a ring (12) with a semi-circular cross section projecting towards the inside of the capillary channel (3) having its axis coinciding with the longitudinal axis (N-N) of the ball-point pen (1).

6. Ball-point pen according to claim 3, in which the said narrow section is formed by a cylindrical shaped restriction (7).

7. Ball-point pen according to claim 3, in which the said narrow section is defined by a ring (12) with a semi-circular cross section projecting towards the inside of the capillary channel (3) having its axis coinciding with the longitudinal axis (N-N) of the ball-point pen (1).
